(19) United States
(12) Patent Application Publication
(10) Pub. No.: US 2021/0357995 A1
(43) Pub. Date: Nov. 18, 2021

(54) INFORMATION PROCESSING DEVICE

(71) Applicant: Maruichi Warehouse Co., Ltd., Yamanashi (JP)

(72) Inventor: Makoto HORIUCHI, Kofu-shi (JP)

(73) Assignee: Maruichi Warehouse Co., Ltd., Yamanashi (JP)

(21) Appl. No.: 17/390,693

(22) Filed: Jul. 30, 2021

Related U.S. Application Data
(63) Continuation of application No. 16/486,289, filed on Aug. 15, 2019.

(30) Foreign Application Priority Data
Feb. 27, 2017 (JP) 2017-035469

(51) Int. Cl. G06Q 30/02; G06Q 30/06; G06Q 50/28

(52) U.S. Cl. CPC G06Q 30/0284; G06Q 50/28; G06Q 30/06

(57) ABSTRACT

The present invention is for calculating a distribution fee for when an article is transported by a moving body. According to the present invention, an article-characteristic-information acquisition unit 81 acquires article characteristic information that has been transmitted from a storage site terminal 3-Q. A moving-body-characteristic-information acquisition unit 82 acquires moving body characteristic information that has been transmitted from the storage site terminal 3-Q. When input information has been transmitted from a user terminal 2, an input-information acquisition unit 80 acquires the input information that has been transmitted from the user terminal 2-P. A fee calculation unit 83 calculates a fee from the article characteristic information acquired by the article-characteristic-information acquisition unit 81, the moving body characteristic information acquired by the moving-body-characteristic-information acquisition unit 82, and the input information acquired by the input-information acquisition unit 80. A fee notification unit 84 notifies the user terminal 2-P of the fee calculated by the fee calculation unit 83.

### CROSS-REFERENCE TO RELATED APPLICATIONS

This present application is a Continuation of U.S. patent application Ser. No. 16/486,289 filed on Aug. 15, 2019, which is the U.S. National Phase of International Application No. PCT/JP2018/007355 filed on Feb. 27, 2018, which claims priority to and the benefit of Japanese Patent Application No. 2017-035469 filed on Feb. 27, 2017, the entire contents of which are incorporated herein by reference.

### TECHNICAL FIELD

The present invention relates to an information processing device.

### BACKGROUND ART

In recent years, the importance of a distribution system has been increasing, and it is an indispensable technology in people's lives. In particular, the use of the distribution system is indispensable in business activities, and the productivity of a company usually varies greatly depending on the cost and price of distribution. In this regard, for example, the technology described in Patent Document 1 has been proposed as a technology for efficiently operating the distribution system and determining and improving the cost and price of distribution (see Patent Document 1). According to the technology described in Patent Document 1, it is possible to construct a distribution system that determines the cost and price of the distribution from information on a range of receiving locations that the customer can accept and makes it more efficient. Such a technique is very useful when delivering products to specific individuals.
Patent Document 1: Japanese Unexamined Patent Application, Publication No. 2002-128279

### DISCLOSURE OF THE INVENTION

### Problems to be Solved by the Invention

The technology described in Patent Document 1 is very useful when delivering products to specific individuals. On the other hand, for example, it is unsuitable for transporting commercial articles of which receiving location is designated. In other words, when a large quantity of commercial products are delivered, the products are usually transported to designated warehouses or the like. For this reason, it is often difficult to change the receiving location, but rather, how to transport a large quantity of products (for example, a transportation route of products, a storage site, and the like) is important in determining the cost and price of distribution.

The present invention was made in light of the foregoing, and it is an object of the present invention that enables a sender to calculate a distribution fee in advance in accordance with an input from a user.

### Means for Solving the Problems

In order to achieve the above object, an information processing device of one aspect of the present invention is: an information processing device that calculates a distribution fee in a case of N (N is an arbitrary integer value) articles are transported from a storage site to a delivery destination via 0 or more bases by M (M is an arbitrary integer value different from N) moving bodies, including:

an article characteristic acquisition section that acquires a first characteristic value of each of the N articles; a moving-body-characteristic acquisition section that acquires a second characteristic value of each of the M moving bodies; an input parameter acquisition section that acquires input parameters including at least a deadline, a cost, and a quality; and
a distribution fee calculation section that calculates a transportation fee of each of the M moving bodies and storage fees of the storage site and the base of each of the N articles, a cargo handling fee of each of the N articles, and a delivery fee of each of the N articles as the distribution fee on the basis of the first characteristic value of each of the N articles, the second characteristic value of each of the M moving bodies, and the input parameters.

### Effects of the Invention

The present invention was made in light of the foregoing, and it is possible to select a desired distribution business operator since the sender can calculate the distribution fees in advance in accordance with an input from the user and compare them.

### BRIEF DESCRIPTION OF THE DRAWINGS

FIG. 1 is a block diagram illustrating a configuration of an information processing system according to an embodiment of the present invention.

FIG. 2 is a block diagram illustrating a hardware configuration of a server of an embodiment of the present invention in the information processing system of FIG. 1.

FIG. 3 is a functional block diagram illustrating an example of functional configurations of a server, a user terminal, and a storage site terminal of FIG. 2.

FIG. 4 is a diagram illustrating an example of a service using a fee calculation process executed by the server of FIG. 3.

FIG. 5 is a diagram illustrating an example of a screen of presenting a calculated fee which is displayed on the user terminal of FIG. 3.

FIG. 6 is a flowchart describing the flow of a fee calculation process executed by the server of FIG. 3.

FIG. 7 is a diagram illustrating an example of a screen of presenting a calculated transport fee which is displayed on the user terminal of FIG. 3, and illustrates an example different from that of FIG. 5.

FIG. 8 is a diagram illustrating an example of an advanced setting screen displayed when a button for performing advanced settings in FIG. 7 is pressed.

FIG. 9 is a diagram illustrating an example of search results displayed in a display region when an input indicating a check is performed in a check area of trunk transport+local transport in the advanced setting screen illustrated in FIG. 8.

### PREFERRED MODE FOR CARRYING OUT THE INVENTION

Hereinafter, an exemplary embodiment of the present invention will be described with reference to the appended drawings.

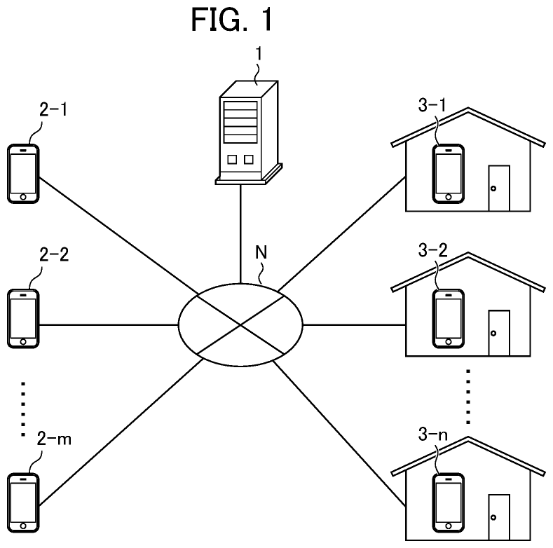

FIG. 1 illustrates a configuration of an information processing system according to an embodiment of the present invention.

As illustrated in FIG. 1, the information processing system of the present embodiment includes a server 1 managed by a provider of an article transport service, user terminals 2-1 to 2-m used by m (m is an arbitrary integer value of 1 or more) users (for example, distribution business operators or the like), and storage site terminals 3-1 to 3-n used by storage site administrators in n (n is an arbitrary integer value of 1 or more) storage sites. The server 1, the user terminals 2-1 to 2-m, and the storage site terminals 3-1 to 3-n are connected to one another via a predetermined network N such as the Internet.

Hereinafter, when it is not necessary to distinguish each of the user terminals 2-1 to 2-m individually, they are referred to collectively as a “user terminal 2”, and hereinafter, when it is not necessary to distinguish each of the storage site terminals 3-1 to 3-n individually, these are referred to collectively as a “storage site terminal 3.”

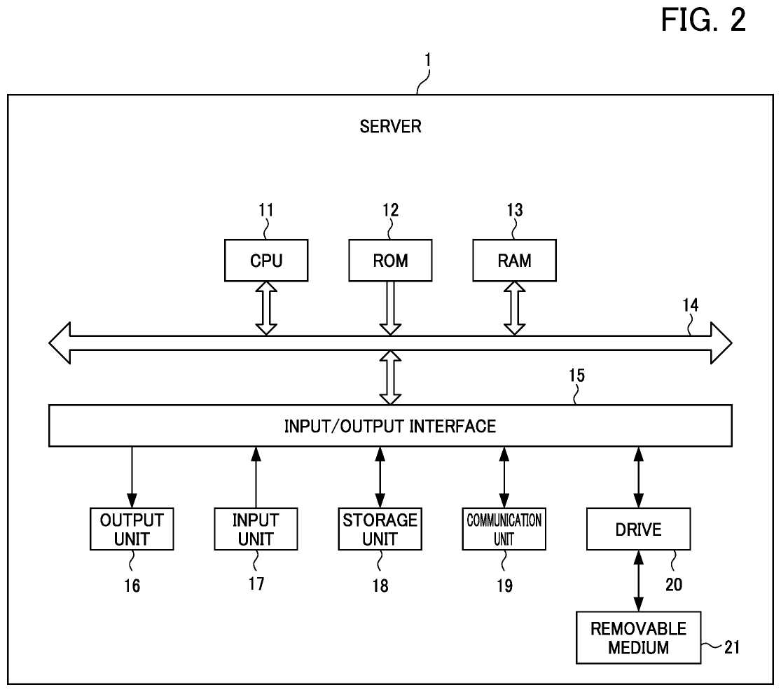

FIG. 2 is a block diagram illustrating a hardware configuration of the server 1 in the information processing system of FIG. 1.

The server 1 includes a central processing unit (CPU) 11, a read only memory (ROM) 12, a random access memory (RAM) 13, a bus 14, an input/output interface 15, an output unit 16, an input unit 17, a storage unit 18, a communication unit 19, and a drive 20.

The CPU 11 executes various types of processes in accordance with various types of programs recorded in the ROM 12 or various programs loaded from the storage unit 18 to the RAM 13. The RAM 13 also stores data necessary for the CPU 11 to execute various types of processes.

The CPU 11, the ROM 12, and the RAM 13 are connected to one another via the bus 14. The input/output interface 15 is also connected to the bus 14. The output unit 16, the input unit 17, the storage unit 18, the communication unit 19, and the drive 20 are connected to the input/output interface 15.

The output unit 16 includes various types of liquid crystal displays and outputs various types of information. The input unit 17 includes various types of hardware and receives various types of information. The storage unit 18 includes a hard disk, a dynamic random access memory (DRAM), or the like, and stores various types of data. The communication unit 19 controls communication performed with other devices (for example, other user terminal 2, the storage site terminal 3, or the like in FIG. 1) via the network N including the Internet.

The drive 20 is installed if necessary. A removable medium 21 including a magnetic disk, an optical disk, a magneto-optical disk, a semiconductor memory, or the like is appropriately mounted on the drive 20. A program read from the removable medium 21 by the drive 20 is installed in the storage unit 18 if necessary. The removable medium 21 can also store various types of data stored in the storage unit 18, similarly to the storage unit 18.

Since the configurations of the user terminal 2 and the storage site terminal 3 are basically similar to the configuration of the server 1, description thereof is omitted here.

With cooperation of various types of hardware and various types of software of the server 1, the user terminal 2, and the storage site terminal 3 in FIG. 2, a process to be described below (hereinafter referred to as a “fee calculation process”) can be executed. Further, an entity that provides a distribution business operator or the like with a series of services (hereinafter referred to as the “present service”) for calculating a fee (hereinafter referred to as a “transport fee”) for transporting an article using to a delivery destination fee calculation process is hereinafter referred to as a “service provider.”

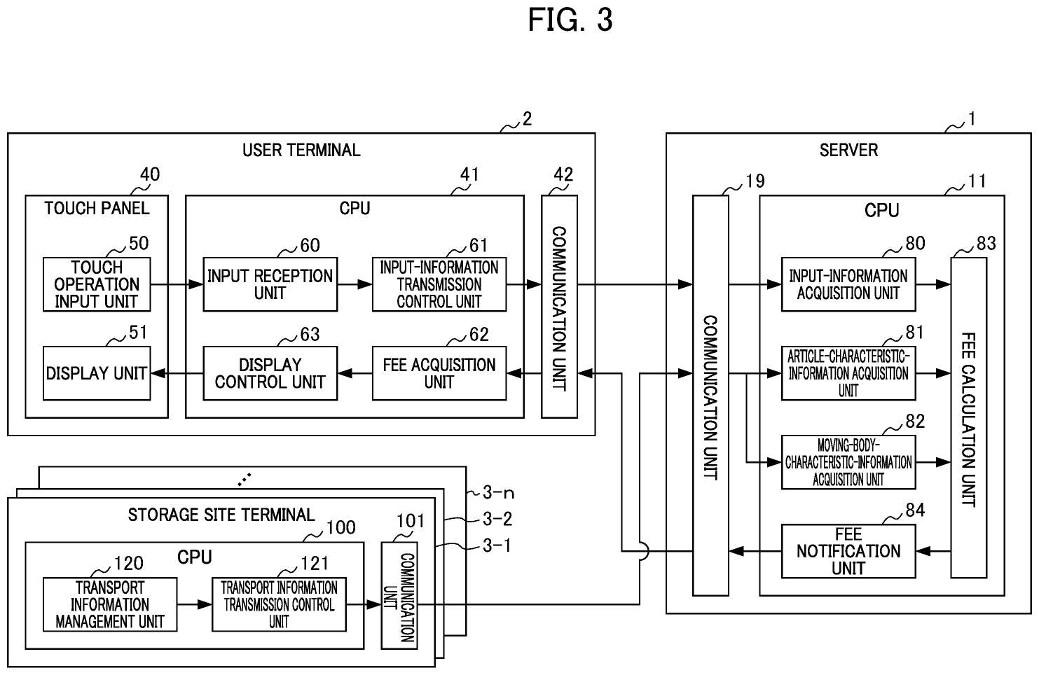

In order to realize the fee calculation process, the server 1, a predetermined user terminal 2-P, and a predetermined storage site terminal 3-Q have functional configurations illustrated in FIG. 3. FIG. 3 is a functional block diagram illustrating an example of functional configurations for the server 1, the user terminal 2-P, and the storage site terminal 3-Q of FIG. 2.

In a CPU 41 of the user terminal 2-P, an input reception unit 60, an input-information transmission control unit 61, a fee acquisition unit 62, and a display control unit 63 function. In a CPU 100 of the storage site terminal 3-Q, a transport information management unit 120 and a transport information transmission control unit 121 function. In the CPU 11 of the server 1, an input-information acquisition unit 80, an article-characteristic-information acquisition unit 81, a moving-body-characteristic-information acquisition unit 82, a fee calculation unit 83, and a fee notification unit 84 function.

The input reception unit 60 of the user terminal 2-P receives input information input by a touch operation of the user via a touch operation input unit 50. Here, the input information is information related to input results of the user (a request and a desire) for predetermined items set by the service provider such as a due date indicating a date for delivering the target article to the delivery destination (hereinafter referred to as a “deadline”), a cost for delivering a target article to a delivery destination (hereinafter referred to as a “cost”), an accident rate or a damage rate for delivering the target article to the delivery destination (hereinafter referred to as a “quality”). That is, the input reception unit 60 receives, as the input information, inputs from the user for the predetermined items set by the service provider such as the deadline, the cost, and the quality. The input-information transmission control unit 61 executes control for transmitting the input information received by the input reception unit 60 to the server 1 via a communication unit 42. Accordingly, the input information transmitted to the server 1 is acquired by the server 1. The server 1 then combines the input information with article characteristic information and moving body characteristic information to be described below to calculate a transport fee and notifies the user terminal 2-P of the transport fee. Accordingly, the fee acquisition unit 62 of the user terminal 2-P acquires the transport fee notified from the server 1. Further, the display control unit 63 executes control for displaying the transport fee acquired by the fee acquisition unit 62 on a display unit 51.

The transport information management unit 120 of the storage site terminal 3-Q acquires and manages various types of information (hereinafter referred to as “transport information”) related to transport of articles including at least the article characteristic information and the moving body characteristic information. Here, the article characteristic information is information indicating characteristics of an article to be transported such as a size, a weight, and whether it is a refrigerated or frozen article. Further, the moving body characteristic information is information indicating characteristics of a moving body that performs transport such as a size of a 4 t vehicle or a 10 t vehicle and a type of a home delivery service, a route service, or a reserved service. A method for acquiring various types of information by the storage site terminal 3-Q is not particularly limited, and for example, the user of the storage site terminal 3-Q may acquire it manually. Also, for example, various types of information may be acquired indirectly from an HDD outside the storage site terminal 3-Q. The transport information transmission control unit 121 transmits the transport information managed by the transport information management unit 120 to the server 1 via a communication unit 101.

Then, the input-information acquisition unit 80 of the server 1 acquires the input information transmitted from the user terminal 2-P via the communication unit 19. That is, the input-information acquisition unit 80 acquires the input information related to the deadline, the cost, the quality, and the like transmitted from the user terminal 2-P. Further, the article-characteristic-information acquisition unit 81 acquires the article characteristic information transmitted from the storage site terminal 3-Q. Further, the moving-body-characteristic-information acquisition unit 82 acquires the moving body characteristic information transmitted from the storage site terminal 3-Q.

The fee calculation unit 83 calculates the transport fee from the input information acquired by the input-information acquisition unit 80, article characteristic information acquired by the article-characteristic-information acquisition unit 81, and the moving body characteristic information acquired by the moving-body-characteristic-information acquisition unit 82. The calculation of the transport fee can be set freely by combining the input information, the article characteristic information, and the moving body characteristic information. In other words, the method of calculating the transport fee can be set freely by the service provider, and each service provider can calculate the transport fee in accordance with a method most appropriate for each service. The fee notification unit 84 notifies the user terminal 2-P of the fee calculated by the fee calculation unit 83 via the communication unit 19.

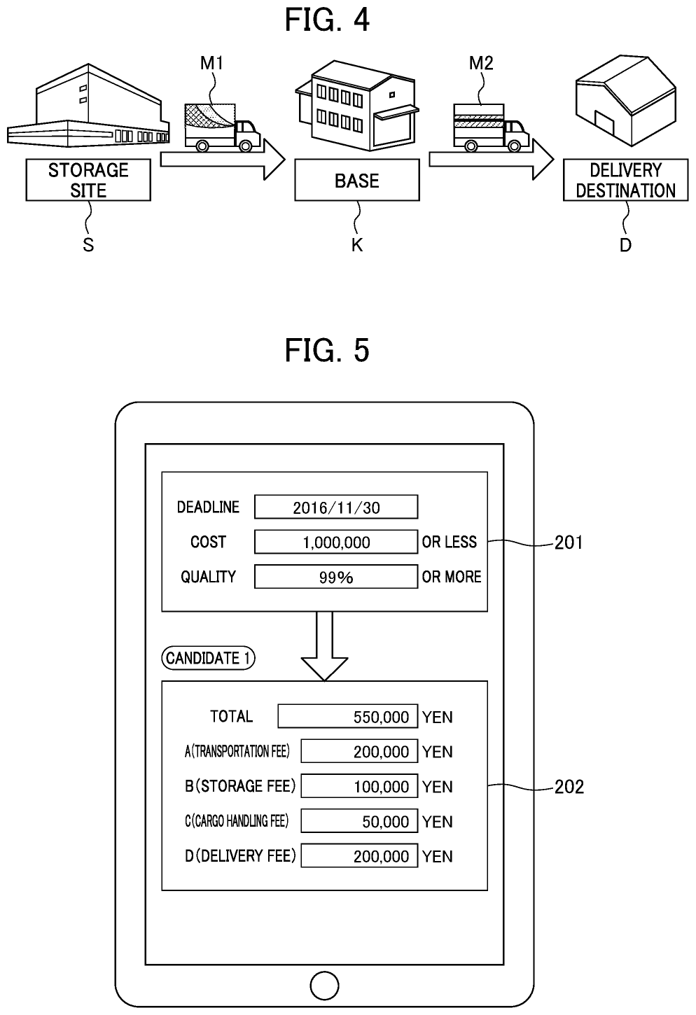

Next, an example of the present service will be described with reference to FIG. 4.

FIG. 4 is a diagram illustrating an example of a service (the present service) using the fee calculation process executed by the server in FIG. 3. Referring to FIG. 4, there are a storage site S, a base K, a delivery destination D, a moving body M1, and a moving body M2. First, the storage site S is, for example, a warehouse in which the articles are stored by the distribution business operators who deliver the articles to the delivery destinations. The base K is a relay destination (such as a warehouse that temporarily stores the articles) used by the distribution business operators that transport the articles to the delivery destinations. The delivery destination D is a warehouse of the delivery destination to which the distribution business operator delivers the articles. The distribution business operator usually transports an article Y stored in the storage site S to the base K using the moving body M1 and temporarily stores the article Y. Then, the distribution business operator or a predetermined distribution business operator different from the distribution business operator transports the article Y temporarily stored in the base K to the delivery destination D using the moving body M2. The service provider performs a service (fee calculation process) for calculating the transport fee related to the transport service in accordance with the input of the user when the article Y is transported. The user who uses the present service can calculate (estimate) the transport fee in advance when the article Y is transported and thus select an optimal transport method in accordance with a plurality of transport routes and conditions.

Here, it is a method for calculating the transport fee by the server 1, but as described above, the server 1 calculates the transport fee by combining the input information, the article characteristic information, and the moving body characteristic information. In other words, in order for the server 1 to calculate the transport fee, it is necessary to acquire the article characteristic information and the moving body characteristic information in addition to the input information. In the example of FIG. 4, the article characteristic information and the moving body characteristic information are acquired by the storage site terminal 3-Q used by the administrator of the storage site S. The administrator who uses the storage site terminal 3-Q inputs the article characteristic information and the moving body characteristic information to the storage site terminal 3-Q appropriately. Accordingly, the storage site terminal 3-Q acquires the article characteristic information and the moving body characteristic information.

Next, an operation performed by the user during the fee calculation process will be described with reference to FIG. 5. FIG. 5 is a diagram illustrating an example of a screen for presenting the calculated transport fee which is displayed on the user terminal 2 of FIG. 3. As illustrated in FIG. 5, the display unit 51 of the user terminal 2 is divided into a display region 201 and a display region 202. The display region 201 includes input areas disposed for three items, that is, the deadline, the cost, and the quality. The user can freely input to the input area of each item in accordance with his/her desired transport conditions. In the example illustrated in FIG. 5, “2016/11/30” is input to the input area of the deadline item. This indicates that the user's desired deadline is Nov. 30, 2016. Similarly, “1,000,000 yen or less” and “99% or more” are input to the input area of the cost item and the input area of the quality item, respectively. This indicates that the user's desired transport fee is 1 million yen or less, and the quality is 99% or more (the damage rate is 1% or less). In the server 1, the transport fee is calculated on the basis of the input information received as such, the article characteristic information described above, and the moving body characteristic information. The calculated transport fee is notified from the server 1 to the user terminal 2 and displayed in the display region 202 of the display unit 51.

As illustrated in FIG. 5, in the display region 202, there is a display of a candidate 1, and items of a total, a transportation fee, a storage fee, a cargo handling fee, and a delivery fee are displayed in order from the top. These items indicate a total transport fee and breakdown amounts when it is transported by a transport route of the candidate 1. In the example of FIG. 5, “550,000 yen” is displayed in the item of the total. This indicates the total cost when it is transported by the transport route of the candidate 1. Similarly, “200,000 yen” is displayed in the item of the transportation fee, “100,000 yen” is displayed in the item of the storage fee, “50,000 yen” is displayed in the item of the cargo handling fee, and “200,000 yen” is displayed in the item of the delivery fee. These displays indicate that the total cost when it is transported by the transport route of the candidate 1 is 550,000 yen, and as the breakdown, 200,000 yen is the transportation fee, 100,000 yen is the storage fee, and 50,000 yen is the cargo handling fee, and 200,000 yen is the delivery fee. Here, the respective items (breakdown) will be briefly described. In other words, the transportation fees include charter fees, refueling fees, and the like of the moving bodies M1 and M2. The storage fee is the storage fee in the storage site S and the base K. Further, cargo handling is a work fee for loading/unloading the articles to/from the moving bodies M1 and M2. The delivery fee is a general expense associated with delivery (for example, a personnel cost). The items displayed as the breakdown of the fee can be freely set by the service provider and are not limited to the items described above. The service provider can select the most appropriate items for providing service and display them on the user terminal 2.

As described above, the user can estimate the transport fee by inputting a request and a desire for predetermined items set by the service provider such as the deadline, the cost, and the quality. If the user estimates the fee and feels it is high, the user can adjust the fee by changing values of the deadline or the quality. Further, when there are a plurality of transport routes, it is possible to freely determine the transport route by comparing and examining the transport fees of the respective transport routes.

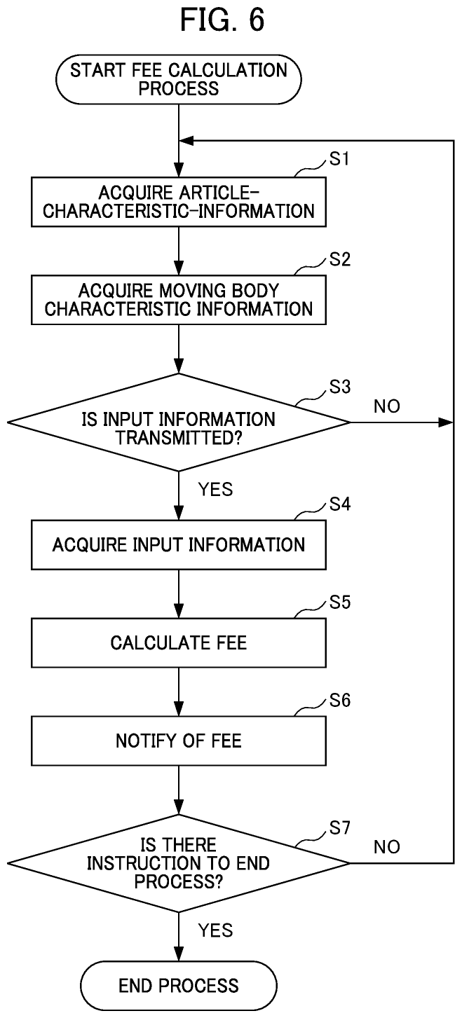

Next, the fee calculation process executed by the server 1 having the functional configuration of FIG. 3 will be described with reference to FIG. 6. FIG. 6 is a flowchart describing the flow of route determination processing executed by the server 1.

In step S1, the article-characteristic-information acquisition unit 81 acquires the article characteristic information from among various types of information transmitted from the storage site terminal 3-Q, that is, for example, a size, a weight, and information indicating whether it is a refrigerated or frozen article for the article to be transported. In step S2, the moving-body-characteristic-information acquisition unit 82 acquires the moving body characteristic information from among various types of information transmitted from the storage site terminal 3-Q.

In step S3, the input-information acquisition unit 80 determines whether or not the input information is transmitted from the user terminal 2. If the input information is not transmitted from any one of the user terminals 2-1 to 2-m, it is determined as NO in step S3, and the process returns to step S1. On the other hand, if the input information is transmitted from the user terminal 2-P, it is determined as YES in step S3, and the process proceeds to step S4. In step S4, the input-information acquisition unit 80 acquires the input information transmitted from the user terminal 2-P in step S3. That is, the input-information acquisition unit 80 acquires the input information such as the deadline, the cost, and the quality transmitted from the user terminal 2-P.

In step S5, fee calculation unit 83 calculates the transport fee related to the transport of the article on the basis of the article characteristic information acquired by the article-characteristic-information acquisition unit 81 acquired in step S1, the moving body characteristic information acquired by the moving-body-characteristic-information acquisition unit 82 in step S2, and various types of information of the input information acquired in step S4. As described above, the method for calculating the transport fee by the fee calculation unit 83 is not particularly limited and can be freely selected by the service provider. Further, in step S6, the fee notification unit 84 notifies the user terminal 2-P of the transport fee calculated by the fee calculation unit 83 in step S5.

In step S7, the CPU 11 of the server 1 determines whether or not there is an instruction to end the process. Here, the instruction to end the process is not particularly limited, but in the present embodiment, a power shutdown of the server 1 is employed. In other words, when the server 1 is powered off, it is determined as YES in step S7, and the process of the server 1 ends. On the other hand, unless the server 1 is powered off, it is determined as NO in step S7, the process returns to step S1, and the subsequent processes are repeated.

The embodiment of the present invention has been described above, but the present invention is not limited to the above-described embodiment. Further, the effects described in the present embodiment are merely a list of most preferable effects resulting from the present invention, and the effects of the present invention are not limited to those described in the present embodiment.

In the above-described embodiment, the items of the deadline, the cost (fare), and the quality (accident rate) are selected as the input information, but these are only examples for explanation, and the present invention is not limited thereto. For example, it is possible to estimate the fee when the user sets the candidate location of the delivery destination and delivers to each delivery destination. Accordingly, the user can also compare the transport fee for each of the delivery destination candidates, and as a result, the article can be transported at a lower cost.

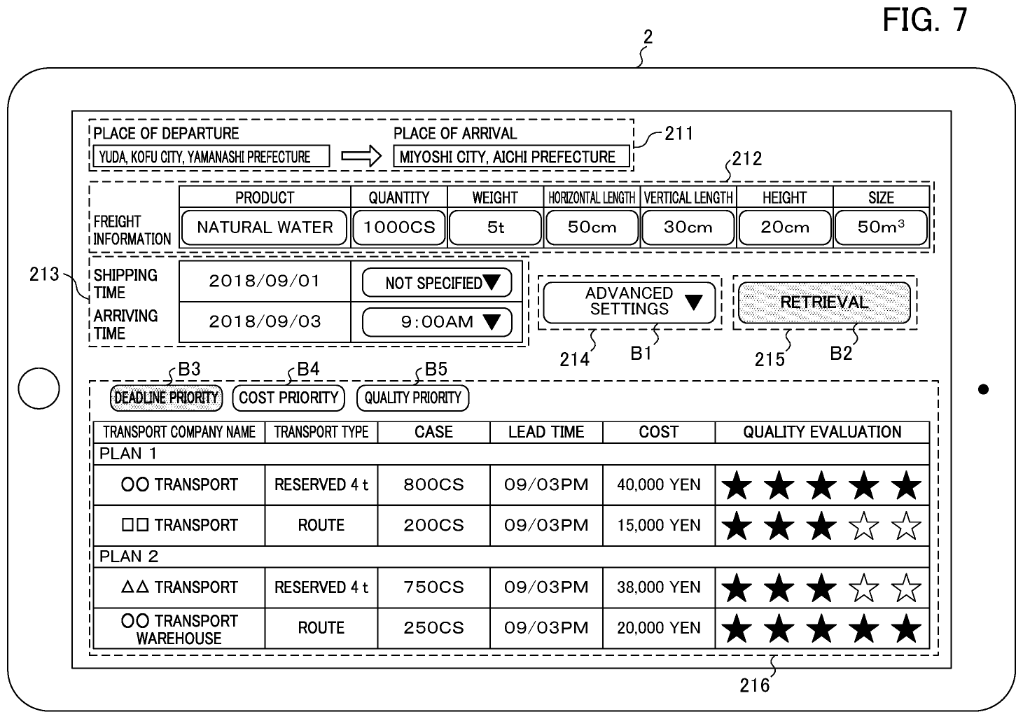

In this case, for example, in the fee calculation process described above, the screen for presenting the transport fee which is displayed on the user terminal 2 is not limited to the embodiment illustrated in FIG. 5. In this regard, a screen different from the screen described in the above-described embodiment will be described below with reference to FIGS. 7 to 9.

First, in the examples illustrated in FIGS. 7 to 9, there are the following three transport section, and two or more transport section are appropriately combined. A first transport section is a home delivery service. In the home delivery service, the transport can be performed in units of freights. The transport fee is determined by a size (including weight) and a distance (a fee is set in units of prefectures). The size is also discretely determined in multiple stages, and if it exceeds a size of a certain stage, the transport fee is determined as the size of the next stage. A second transport section is a route service. In the route service, a plurality of freights of 1 ton or less are combined and transported, that is, mixedly loaded. In the route service, there is a merit that the transport fare is cheaper, but there is also a demerit that the delivery time is unable to be designated because it runs on a regular basis, similarly to a fixed route bus. A third transport section is a reserved service. In the reserved service, it is possible to reserve a truck or transport within weight restrictions of the truck. As the truck, 2 t, 4 t, and 10 t vehicles can be selected depending on a loading weight. In the reserved service, the number of tracks is largest among the three transport section. Dedicated trucks such as refrigerated, frozen, and bulk vehicles can be used in the reserved service. In the reserved service, there is a merit that the transport is performed as requested by the sender if the loading weight and the working hours are respected, but there is also a demerit that there are too many transport companies to know a company to ask.

FIG. 7 illustrates an example of a screen for presenting the calculated transport fee which is displayed on the user terminal 2 of FIG. 3, and illustrates an example different from that of FIG. 5. In addition to the transport fee, a transport company name, a transport type, a case (quantity), a lead time (arriving time), and evaluation (quality evaluation) of a service level as a transport company are displayed in the screen in the example of FIG. 7. The quality evaluation is indicated by black stars which increase in number as the service level gets better.

Referring to FIG. 7, the display unit 51 of the user terminal 2 is divided into display regions 211 to 216. Input areas for two items, that is, a place of departure and a place of arrival are disposed in the display region 211. The user can freely input the place of departure and the place of arrival of a freight desired to be transported to the input areas of these two items. In the example of FIG. 7, “Yuda, Kofu City, Yamanashi Prefecture” is input to the input area of the place of departure item. This indicates that the place of departure of the freight desired to be transported by the user is Yuda in Kofu City, Yamanashi Prefecture. Further, “Miyoshi City, Aichi Prefecture” is input to the input area of the place of arrival item. This indicates that the place of arrival of the freight desired to be transported by the user is Miyoshi City, Aichi Prefecture.

In the display region 212, input areas are disposed for seven items, that is, a product name, a quantity, a weight, a horizontal length, a vertical length, a height, and a size (volume) as items related to the freight information. The user can freely input the product name, the quantity, the weight, the horizontal length, the vertical length, the height, and the size (volume) of the freight desired to be transported to these seven input areas. In the example of FIG. 7, “natural water” is input to the input area of the item of the product. This indicates that the product name of the freight desired to be transported by the user is natural water. Further, “1000 CS” is input to the input area of the item of the quantity. This indicates that the quantity of the freight desired to be transported by the user is 1000 CS (cases). Also, “5 t” is input to the input area of the item of the weight. This indicates that the weight of the freight desired to be transported by the user is 5 t (ton). Also, “50 cm” is input to the input area of the item of horizontal. This indicates that the horizontal length of the freight desired to be transported by the user is 50 cm (centimeter). Further, “30 cm” is input to the input area of the item of vertical. This indicates that the vertical length of freight desired to be transported by the user is 30 cm. Also, “20 cm” is input to the input area of the item of high. This indicates that the height of the freight desired to be transported by the user is 20 cm. Also, “50 m³” is input to the input area of the item of the size. This indicates that the volume of the freight desired to be transported by the user is 50 m³ (cubic meter).

In the display region 213, input areas are disposed for two items, that is, a shipping time and an arriving time. The user can freely input a date and time at which the freight desired to be transported is desired to be shipped and a date and time at which the freight desired to be transported is desired to arrive to the input areas of these two items. In the example illustrated in FIG. 7, “2018/09/01” and “Not specified” are input to the input areas of the item of the shipping time. This indicates that the shipping date of the freight is Sep. 1, 2018, and that the shipping time of the freight is not specified.

“2018/09/01” and “not specified” are input to the input area of the item of the shipping time. This indicates that a date at which the freight desires to arrive is Sep. 3, 2018 and that a time at which freight desires to arrive is 9 A.M.

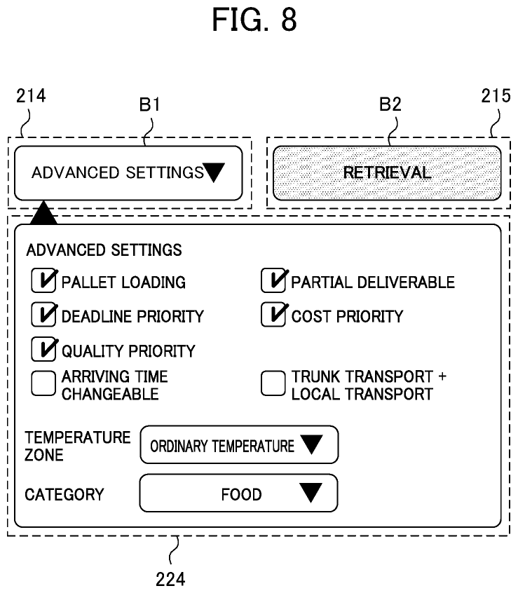

A button B1 for performing advanced settings is disposed in the display region 214. The user can perform advanced settings by pressing this button. If the button B1 is pressed, the display region 224 illustrated in FIG. 8 is displayed as a pop-up menu.

FIG. 8 is a diagram illustrating an example of the advanced setting screen displayed when the button for performing advanced settings in FIG. 7 is pressed. Referring to FIG. 8, in the display region 224, input areas by check are disposed for seven items for advanced settings, that is, pallet loading, partial deliverable, deadline priority, cost priority, quality priority, arriving time changeable, and trunk transport+local transport. The user can input the transport conditions desired by the user to these input areas by checking. In the example of FIG. 8, an input indicating a check is performed in the check area of the pallet loading. This indicates that the user desires loading by the pallet. Further, an input indicating a check is performed in the check area of partial deliverable. This indicates that the user approves dividing and transporting freights. Further, an input indicating a check is performed in the check area of deadline priority. This indicates that the user desires presentation of a transport pattern in which a priority is given to the deadline among the three items of the deadline, the cost, and the quality. When an input indicating a check is performed in the check area of deadline priority, a transport plan suitable when the deadline is given a priority is displayed as retrieval results displayed in a display region 216 to be described later. Further, an input indicating a check is performed in the check area of cost priority. This indicates that the user desires presentation of a transport pattern in which a priority is given to the cost among the three items of the deadline, the cost, and the quality. If an input indicating a check is performed in the check area of cost priority, a transport plan suitable when the cost is given a priority is displayed as retrieval results displayed in the display region 216 to be described later. Further, an input indicating a check is performed in the check area of quality priority. This indicates that the user desires presentation of a transport pattern in which a priority is given to the quality among the three items of the deadline, the cost, and the quality. If an input indicating a check is performed in the check area of quality priority, a transport plan suitable when the quality is given a priority is displayed as retrieval results displayed in the display region 216 to be described later. Further, an input indicating a check not performed in the check area of arriving time changeable. This indicates that the user is unable to change the arriving time of freight. Further, an input indicating a check is not performed in the check area of trunk transport+local transport. This indicates that the user is unable to use transport in which both the trunk transport and the local transport combined.

In the display region 224, input areas by selection are disposed for two items, a temperature zone and a category. The user can input transport conditions to the input areas by selection of the two items by selection. In the example of FIG. 8, “ordinary temperature” is selected in the selection area of the temperature zone item. This indicates that the user desires transport at ordinary temperature as the freight temperature environment. Further, “food” is selected in the category selection area. This indicates that the user has selected food as the category to which the freight belongs.

Referring again to FIG. 7, a button B2 for performing a retrieval is disposed in the display region 215. If the button B2 is pressed, the server 1 specifies the article characteristic information, the moving body characteristic information, and information of parameters related to the deadline, the quality, and the cost from the transport conditions input in the respective input areas. The server 1 calculates the transport fee for each transport company on the basis of the specifying results, determines one or more transport company combinations suitable for the transport conditions on the basis of the calculation results, and notifies the user terminal 2 of them as the transport plan. The transport pattern notified to the user terminal 2 is displayed in the display region 216 of the display unit 51. Specifically, the transport plan suitable for the transport conditions input to the respective input areas is displayed in the display region 216. In the display region 216, six items, that is, the transport company, the transport type, the case (quantity), the lead time (arriving time), the cost (transport fee), and the quality evaluation are displayed for each transport plan as the items related to the transport plan.

The user can change and compare the transport plan by selectively setting each of the deadline, the quality, and the cost as an item to be given a priority. That is, as illustrated in FIG. 7, the user can switch the display of the transport plan by pressing any one of a button B3 for displaying the transport plan in which the deadline is given a priority, a button B4 for displaying the transport plan in which the cost is given a priority, and a buttons B5 for displaying the transport plan in which the quality is given a priority is pressed.

In the example in FIG. 7, since the button B3 is in the pressed state, the transport plan in which the deadline is given priority is displayed. Specifically, two transport plans, that is, a transport plan 1 and a transport plan 2, are displayed. Of these, in the transport plan 1, content of five items, that is, the transport type, the case (quantity), the lead time (arriving time), the cost (transport fee), and the quality evaluation are displayed for each of two transport companies, that is, a ◯◯ Transport and a □□ Transport. This indicates that the transport plan 1 is a transport plan in which the two transport companies, that is, the ◯◯ Transport and the □□ Transport are used together. Of these two transport companies, in the ◯◯ Transport, when freights of 800 CS (case) arrive on the afternoon of September 3 using the reserved 4 t vehicle, the fee is 40,000 yen, and the quality evaluation from the user is 5 stars. Further, in the □□ Transport, when freights of 200 CS (case) arrive on the afternoon of September 3 using the route service, the fee is 15,000 yen, and the quality evaluation from the user is 4 stars. Further, in the transport plan 2, similarly to the transport plan 1, content of five items, that is, the transport type, the case (quantity), the lead time (arriving time), the cost (transport fee), and the quality evaluation are displayed for each of two transport companies, that is, a ΔΔ Transport and the ◯◯ Transport. This indicates that the transport plan 2 is a transport plan in which the two transport companies, that is, the ΔΔ Transport and the ◯◯ Transport are used together. Of these two transport companies, in the ΔΔ Transport, when freights of 750 CS (case) arrive on the afternoon of September 3 using the reserved 4 t vehicle, the fee is 38,000 yen, and the quality evaluation from the user is 3 stars. Further, in the ◯◯ Transport, when freights of 250 CS (case) arrive on the afternoon of September 3 using the route service, the fee is 20,000 yen, and the quality evaluation from the user is 5 stars.

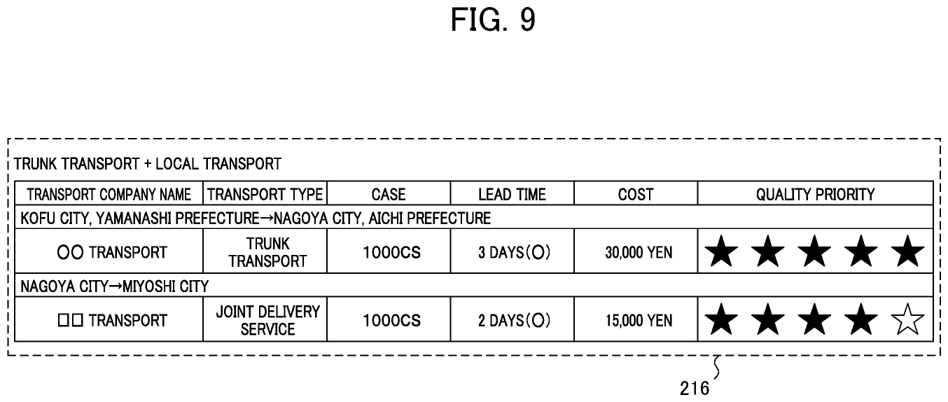

Here, in the example of FIG. 8, in the advanced settings, no input indicating a check is performed in the check area of trunk transport+local transport, but when an input indicating a check is performed in the check area, this indicates that the user allows the use to use trunk transport+local transport together. If an input indicating a check is performed in the check area of trunk transport+local transport, search results illustrated in FIG. 9 are displayed in the display region 216. FIG. 9 is a diagram illustrating an example of search results displayed in the display region 216 when an input indicating a check is performed in the check area of trunk transport+local transport in the advanced setting screen illustrated in FIG. 8. In the example of the screen of FIG. 9, the transport company name, the transport type, case (quantity), the lead time (landing time), the cost (transport fee), and the evaluation (quality evaluation) of the service level as the transport company are displayed. This quality evaluation is indicated by black stars that increase in number as the service level gets better. In the example of FIG. 9, a transport plan in which the ◯◯ Transport is responsible for the transport from Kofu City, Yamanashi Prefecture to Nagoya City, Aichi Prefecture, and the □□ Transport is responsible for the transport from Nagoya City, Aichi Prefecture to Miyoshi City, Aichi Prefecture is displayed as the search results. Specifically, for each of the two transport companies, the ◯◯ Transport and the □□ Transport, content of the five items, that is, the transport type, the case (quantity), the lead time (landing time), the cost (transport fee), and the quality evaluation is displayed. This indicates that it is a transport plan in which the two transport companies, that is, the ◯◯ Transport responsible for the transport of the trunk transport is cooperated with the □□ Transport responsible for the transport of the local transport. Further, of these two transport companies, in the ◯◯ Transport, when freights of 1000 CS (case) are transported for three days using the trunk transport from Kofu City, Yamanashi Prefecture to Nagoya City, Aichi Prefecture, the fee is 30,000 yen, and the quality evaluation from the user is 5 stars. Further, in the □□ Transport, when freights of 1000 CS (case) transported to Nagoya City, Aichi Prefecture by the ◯◯ Transport are transported for two days using the route service to Miyoshi City, Aichi Prefecture, the fee is 15,000 yen, and the quality evaluation from the user is 4 stars.

As described above, the user can check content of one or more transport plans suitable for the transport conditions by inputting the transport conditions to predetermined items set by the service provider such as the deadline, the cost, and the quality. Accordingly, when there are a plurality of transport plans, the user can compare and examine content of each transport plan and select a preferred transport plan. For example, if the user feels that the cost (transport fee) is high or the quality evaluation is low as a result of checking content of one or more transport plans displayed as the search results, the user can adjust the content of the transport plan by changing and inputting the transport conditions that are parameters of the transport plan.

Further, for example, in the above-described embodiment, information such as, for example, a size of an article to be transported, a weight thereof, and whether it is a refrigerated/frozen article have been described as the article characteristic value information, but they are merely examples, and the present invention is not limited thereto. For example, any information indicating characteristics of an article such as whether or not an article is a precision machine and whether or not there is a possibility of damage can be used.

Also, for example, in the above-described embodiment, for example, the information on the capacity of the moving body (the size such as the 4 t vehicle or the 10 t vehicle) and the information on the type of the home delivery service, the route service, or the reserved service have been described as the moving body characteristic information, but these are merely illustrative examples, and the present invention is not particularly limited thereto. For example, any information indicating the characteristics of the moving body such as a vehicle model, fuel consumption, or the like of the moving body can be used. Further, for example, the moving body information may include information on the driver of the moving body, for example, the driver's compliance (including working conditions). Further, the transport fee may also be calculated by combining completely different pieces of information other than the input information, the article characteristic information, and the moving body characteristic information for the calculation of the transport fee.

Further, for example, in the above-described embodiment, the fee calculation method is not particularly mentioned, but the service provider may calculate the fee by any method. For example, it is also possible to add a setting of discounting the cargo handling fee when a specific condition is met or a setting of discounting the storage fee when an article is stored in a specific region. Accordingly, the service provider can provide a service that is more convenient for the user by calculating the fee in a method that is optimal for the service itself.

Further, for example, the above embodiment has been described using the example in which the number of transport route candidates is one with reference to FIG. 5, but the number of transport route candidates may be two or more. If there are a plurality of transport route candidates, a plurality of transport route candidates may be displayed on the same screen, or other transport route candidates may be displayed separately.

In the above-described embodiment, the information processing device of the present invention includes the server 1, the user terminal 2 and the storage site terminal 3, but it is only an example to achieve the objects of the present invention, and the present invention is not particularly limited. For example, a terminal may be installed in the base K or the moving body M and added to the configuration of the present invention.

Each of the hardware components illustrated in FIG. 2 is merely an example for achieving the objects of the present invention, and the present invention is not particularly limited.

Further, the functional block diagram illustrated in FIG. 3 is merely an example, and the present invention is not particularly limited. That is, as long as the information processing system has the function capable of executing a series of processes described above as a whole, a functional block used to realize this function is not particularly limited to the example of FIG. 3.

Further, the location of the functional block is not limited to that illustrated in FIG. 3 but may be arbitrary. For example, at least some of the functional blocks on the server 1 side may be disposed on either the user terminal 2 side or the storage site terminal 3 side or vice versa. Further, one functional block may be configured with hardware alone or in combination with software alone.

In the above-described embodiment, each of the user terminal 2 and the storage site terminal 3 is configured with a smart phone but may be configured with an arbitrary device including a tablet or a future new device in addition to a smart phone.

In a case in which the process of each functional block is executed by software, a program that configures the software is installed in a computer or the like from a network or a recording medium. The computer may be a computer which is incorporated in dedicated hardware. The computer may be a computer capable of executing various types of functions by installing various types of programs such as a general-purpose smart phone or personal computer other than a server.

A recording medium containing such a program is not only configured with a removable medium which is distributed separately from a main body of a device in order to provide the program to each user but also a recording medium which is provided to each user in a state in which it is installed in a main body of a device in advance.

In the present specification, steps of describing the program to be recorded on the recording medium include not only, as a matter of course, processes which are executed chronologically according to its order but also processes which are executed in parallel or individually although not necessarily in chronological order.

In summary, the information processing device to which the present invention is applied is sufficient if the present invention has the following configuration, and various embodiments may be taken. That is, the information processing device to which the present invention is applied is an information processing device that calculates a distribution fee in a case of N (N is an arbitrary integer value) articles are transported from a storage site to a delivery destination via 0 or more bases by M (M is an arbitrary integer value different from N) moving bodies, including:

an article characteristic acquisition section (for example, the article-characteristic-information acquisition unit 81 of FIG. 3) that acquires a first characteristic value of each of the N articles;
a moving-body-characteristic acquisition section (for example, the moving-body-characteristic-information acquisition unit 82 of FIG. 3) that acquires a second characteristic value of each of the M moving bodies;
an input parameter acquisition section (for example, the input-information acquisition unit 80 of FIG. 3) that acquires input parameters including at least a deadline, a cost, and a quality; and
a distribution fee calculation section (for example, the fee calculation unit 83 of FIG. 3) that calculates a transportation fee of each of the M moving bodies and storage fees of the storage site and the base of each of the N articles, a cargo handling fee of each of the N articles, and a delivery fee of each of the N articles as the distribution fee on the basis of the first characteristic value of each of the N articles, the second characteristic value of each of the M moving bodies, and the input parameters.
By applying such information processing device, the service provider can provide a technology of calculating the transport fee in a case of an article is transported by the moving body in accordance with the user's desire (input).

Also, the information processing device further includes a distribution fee notification section (for example, the fee notification unit 84 of FIG. 3) that notifies a user terminal (for example, the user terminal 2 of FIG. 3) of the distribution fee calculated by the distribution fee calculation section; and

a display control section (for example, the display control unit 63 of FIG. 3) that executes control for causing the distribution fee notified by the distribution fee notification section to be displayed on the user terminal.
Accordingly, the user can estimate the transport fee for transporting the article by the moving body in accordance with his/her request (input). Further, by comparing and examining the estimated transport fee, the user can transport the article using the candidate of the optimal transport route for the user as a result.

Further, it is possible to construct a comprehensive platform related to the transport of the freight capable of providing the transport plan which is a transport plan based on the deadline, the cost (transport fee), and the quality and provided in consideration of a combination of the demand of the sender or the transport type which is not supported in the related art. In other words, it is possible to establish a novel transport system which is suitable for both the sender and the transport company from the viewpoints of the deadline, the cost, and the quality and not provided in the related art since “non-transportable” is assumed. Specifically, from the viewpoint of the “deadline,” it is switched to local delivery by associating the demand and the delivery destination and creating a depot base (a small distribution base) near the delivery destination. Accordingly, it is possible to cope with a situation in which medium- and long-haul services are drastically decreasing. Further, from the viewpoint of the “cost”, a delivery lead time is increased, and an emergency distribution is shifted to a planned distribution.

Accordingly, it is possible to reduce the transport cost which is increasing due to lack of trucks and drivers. Also, from the viewpoint of the “quality”, an environment in which everyone can work is created. Accordingly, it is possible to eliminate a manpower shortage. As a result, it is possible to solve the problems caused by the changes in the distribution environment. For example, it is possible to solve a problem of a soaring truck fare caused by an extreme shortage of drivers, a problem of shrinking transport opportunities caused by total volume control, a problem of distribution itself that is shifting from the labor-intensive industry to the robotics industry, and a problem that a collection closing time at a route company is advanced.

### EXPLANATION OF REFERENCE NUMERALS

1: SERVER, 2, 2-1 to 2-P: USER TERMINAL, 3, 3-1 to 3-Q: STORAGE SITE TERMINAL, 11: CPU, 41: CPU, 60: INPUT RECEPTION UNIT, 61: INPUT-INFORMATION TRANSMISSION CONTROL UNIT, 62: FEE ACQUISITION UNIT, 63: DISPLAY CONTROL UNIT, 80: INPUT-INFORMATION ACQUISITION UNIT, 81: ARTICLE-CHARACTERISTIC-INFORMATION ACQUISITION UNIT, 82: MOVING-BODY-CHARACTERISTIC-INFORMATION ACQUISITION UNIT, 83: FEE CALCULATION UNIT, 84: FEE NOTIFICATION UNIT, 100: CPU, 120: TRANSPORT INFORMATION MANAGEMENT UNIT, 121: TRANSPORT INFORMATION TRANSMISSION CONTROL UNIT, 201, 202, 211 TO 216, 224: DISPLAY REGION, B1 TO B5: BUTTON

1. A non-transitory computer readable medium storing an information processing program that causes execution of control processing by a computer that executes control to display, on a display medium, an image including at least one of a transport plan and a transport fee related to a transport of one or more articles using one more moving bodies, transported from a storage site to a delivery destination via one or more bases, the control processing comprises functionality for:
acquiring a first characteristic value with respect to each of the one or more articles to be transported, wherein the first characteristic value is related to at least one of, size and weight of the article, whether the article can be transported at room temperature, whether the article is a precision machine, and the possibility of damage;
acquiring a second characteristic value with respect to each of the one or more moving bodies transporting one or more articles, wherein the second characteristic value is related to at least one of, size of the moving body, transporting manner, a vehicle model and fuel consumption of the moving body, and compliance for drivers driving the moving body, including working conditions;
acquiring input parameters including at least a deadline indicating a due date for delivering a target article to a delivery destination, a cost for delivering a target article to a delivery destination as the transport fee, and a quality indicating an accident rate or a damage rate for delivering a target article to a delivery destination;
calculating, based on the first characteristic value, the second characteristic value and the input parameters, a transportation fee of each of the one or more moving bodies, storage fees of the storage site and the base of each of the one or more articles, a cargo handling fee of each of the one or more articles, and a delivery fee of each of the one or more articles as a distribution fee; and
displaying, on the display medium depending on performing advanced settings, the transport plan and a corresponding transport fee, that prioritizes one of the deadline, the cost and the quality, wherein the display medium includes the image that can be selected by a user for prioritizing any of the deadline, the cost and the quality,
wherein the advanced settings, on the display medium, input areas by checking are disposed for a plurality of items for advanced settings including pallet loading, partial deliverable, deadline priority, cost priority, quality priority, arriving time changeable, and trunk transport+local transport, wherein the user can input the transport conditions desired by the user to these input areas by checking.

2. The non-transitory computer readable medium storing an information processing program according to claim 1, wherein the transporting manner includes:
home delivery service that can be transported in units of freights and the transport fee is determined by a size, weight of the freights and transportation distance;
route service that carrying plurality of freights together and transport them on a regular basis; and
reserved service that allows to reserve a truck and transport within weight restrictions of the truck.

3. An information processing method executed by an information processing device that executes control to display, on a display medium, an image including at least one of a transport plan and a transport fee related to a transport of one or more articles using one more moving bodies, transported from a storage site to a delivery destination via one or more bases, the information processing method comprising:
acquiring a first characteristic value with respect to each of the one or more articles to be transported, wherein the first characteristic value is related to at least one of, size and weight of the article, whether the article can be transported at room temperature, whether the article is a precision machine, and the possibility of damage;
acquiring a second characteristic value with respect to each of the one or more moving bodies transporting one or more articles, wherein the second characteristic value is related to at least one of, size of the moving body, transporting manner, a vehicle model and fuel consumption of the moving body, and compliance for drivers driving the moving body, including working conditions;
acquiring input parameters including at least a deadline indicating a due date for delivering a target article to a delivery destination, a cost for delivering a target article to a delivery destination as the transport fee, and a quality indicating an accident rate or a damage rate for delivering a target article to a delivery destination;
calculating, based on the first characteristic value, the second characteristic value and the input parameters, a transportation fee of each of the one or more moving bodies, storage fees of the storage site and the base of each of the one or more articles, a cargo handling fee of each of the one or more articles, and a delivery fee of each of the one or more articles as a distribution fee; and
displaying, on the display medium depending on performing advanced settings, the transport plan and a corresponding transport fee, that prioritizes one of the deadline, the cost and the quality, wherein the display medium includes the image that can be selected by a user for prioritizing any of the deadline, the cost and the quality,
wherein the advanced settings, on the display medium, input areas by checking are disposed for a plurality of items for advanced settings including pallet loading, partial deliverable, deadline priority, cost priority, quality priority, arriving time changeable, and trunk transport+local transport, wherein the user can input the transport conditions desired by the user to these input areas by checking.

4. The information processing method executed by the information processing device according to claim 3, wherein the transporting manner includes:
home delivery service that can be transported in units of freights and the transport fee is determined by a size, weight of the freights and transportation distance;
route service that carrying plurality of freights together and transport them on a regular basis; and
reserved service that allows to reserve a truck and transport within weight restrictions of the truck.
